(19) United States
(12) Patent Application Publication
(10) Pub. No.: US 2026/0358108 A1
(43) Pub. Date: Nov. 12, 2026

(54) Tape Measure with Automatic Locking

(71) Applicant: Milwaukee Electric Tool Corporation, Brookfield, WI (US)

(72) Inventors: Thomas J. Schneider, Milwaukee, WI (US); Moises Guerrero, JR., Milwaukee, WI (US); Brandon A. Apostal, Gurnee, IL (US); Devin W. Herritz, Sussex, WI (US); Matthew A. Wills, Shorewood, WI (US)

(21) Appl. No.: 19/657,594

(22) Filed: Apr. 24, 2026

Related U.S. Application Data
(60) Provisional application No. 63/803,045, filed on May 9, 2025.
(60) Provisional application No. 63/826,094, filed on Jun. 18, 2025.
(60) Provisional application No. 63/837,349, filed on Jul. 2, 2025.
(60) Provisional application No. 63/864,611, filed on Aug. 15, 2025.

(51) Int. Cl. G01B 3/1007; G01B 3/1005

(52) U.S. Cl. CPC G01B 3/1007; G01B 2003/1012; G01B 2003/1035

(57) ABSTRACT

Various embodiments of a tape measure, including an auto locking brake mechanism are provided. The break mechanism is biased to engage a tape blade and/or tape reel positioned within a housing and configured to prevent retraction until the brake mechanism is disengaged. In specific embodiments, the brake mechanism includes a wedge brake with an engagement surface that includes various angles and/or curvatures.

### CROSS-REFERENCE TO RELATED PATENT APPLICATIONS

This application claims the benefit of and priority to U.S. Provisional Application No. 63/864,611, filed Aug. 15, 2025, U.S. Provisional Application No. 63/837,349, filed Jul. 2, 2025, U.S. Provisional Application No. 63/826,094, filed Jun. 18, 2025, and U.S. Provisional Application No. 63/803,045, filed May 9, 2025, which are incorporated herein by reference in their entireties.

### BACKGROUND OF THE INVENTION

The present invention relates generally to the field of tools. The present invention relates specifically to a tape measure, measuring tape, retractable rule, etc., that includes an automatic lock. Such a tape measure includes a brake mechanism that is biased to engage the tape blade and/or tape reel to prevent tape retraction until the brake is disengaged.

Tape measures are measurement tools used for a variety of measurement applications, including in the building and construction trades. Some tape measures include a graduated, marked blade wound on a reel and also include a retraction system for automatically retracting the blade onto the reel. In some such tape measure designs, the retraction system is driven by a coil or spiral spring that is tensioned, storing energy as the tape is extended, and that releases energy to spin the reel, winding the blade back onto the reel such that automatic or non-manual tape retraction is provided. In some other tape measure designs, retraction of the tape is controlled via a manual crank, and such tape measure blades tend to have a long length.

### SUMMARY OF THE INVENTION

One embodiment of the invention relates to a tape measure. The tape measure includes a housing, an axle coupled to the housing, a reel rotatably mounted within the housing around the axle and an elongate blade wound around the reel. The tape measure further includes an actuator at least partially positioned within the housing, a brake arm positioned within the housing and extending from the actuator, a brake pivotally coupled to the brake arm, and a compression spring. The compression spring with a first end and a second end opposite the first end. The first end interfaces against an interior surface of the housing and the second end engages the brake arm. The compression spring biases the brake into engagement with the elongate blade to resist retraction of the elongate blade.

Another embodiment of the invention relates to a tape measure. The tape measure includes a housing, an axle coupled to the housing, a reel mounted within the housing and rotatable about the axle, and an elongate blade wound around the reel. The tape measure further includes an actuator extending at least partially outside the housing, a brake arm positioned within the housing and extending from the actuator, a housing protrusion positioned within the housing between the brake arm and the reel, and a brake pivotally coupled to the brake arm. The brake includes an upper surface configured to engage the housing protrusion and a lower surface opposing the upper surface and configured to engage the elongate blade to resist retraction of the elongate blade. The tape measure includes a biasing component positioned between an interior surface of the housing and the brake arm. The biasing component biases the brake toward engagement with the elongate blade.

Another embodiment of the invention relates to a tape measure. The tape measure includes a housing, an axle coupled to the housing, a reel rotatably mounted to the housing and rotatable about the axle, and a tape blade wound around the reel. The tape measure further includes an actuator extending at least partially outside the housing, a brake arm positioned within the housing and extending from the actuator and including an engagement portion, a housing protrusion positioned within the housing between the brake arm and the reel, and a brake coupled to the engagement portion of the brake arm. The brake includes an upper surface and a lower surface opposing the upper surface and configured to engage the tape blade to resist retraction of the tape blade. The tape measure includes a biasing component positioned between a surface of the housing and the brake arm. The biasing component biases the brake toward engagement with the tape blade.

Another embodiment of the invention relates to an auto locking brake mechanism for a tape measure. The brake mechanism includes an actuator, a brake arm extending from the actuator, a brake coupled to the brake arm, and a biasing component. The biasing component moves the brake into engagement with a reel and/or tape blade of a tape measure to resist retraction of the tape blade. The brake includes a roller with an engagement surface configured to engage the reel and/or tape blade. The roller is coupled to a shaft that is rotatably engaged with the brake arm. The shaft includes a first projection and a second projection. The first projection and the second projection extend radially outward from the shaft.

In a specific embodiment, the biasing component is a cylindrical spring. In a specific embodiment, the biasing component is a conical spring. In a specific embodiment, the biasing component is a torsion spring.

Additional features and advantages will be set forth in the detailed description which follows, and will be readily apparent to those skilled in the art from the description or recognized by practicing the embodiments as described in the written description and/or shown in the accompany drawings. It is to be understood that both the foregoing general description and the following detailed description are exemplary.

The accompanying drawings are included to provide further understanding and are incorporated in and constitute a part of this specification. The drawings illustrate one or more embodiments and, together with the description, serve to explain principles and operation of the various embodiments.

### BRIEF DESCRIPTION OF THE DRAWINGS

This application will become more fully understood from the following detailed description, taken in conjunction with the accompanying figures, wherein like reference numerals refer to like elements in which:

FIG. 1 is a side view of a tape measure with an autolock, according to an exemplary embodiment.

FIG. 2 is a perspective view of the tape measure of FIG. 1 with a portion of the tape blade extended from the housing, according to an exemplary embodiment.

FIG. 3 is a side view of the tape measure of FIG. 1 with a portion of the housing opened, according to an exemplary embodiment.

FIG. 4 is a side view of the tape measure of FIG. 1 with a portion of the housing open and the autolock in a disengaged position.

FIG. 5 is a side view of the tape measure of FIG. 1 with a portion of the housing open and the autolock in a first engagement position.

FIG. 6 is a side view of the tape measure of FIG. 1 with a portion of the housing open and the autolock in a second engagement position.

FIG. 7 is a side view of the tape measure of FIG. 1 with a portion of the housing open and the autolock in third engagement position.

FIG. 8 is a side view of a wedge of the autolock, according to an exemplary embodiment.

FIG. 9 is a detailed side view of the wedge of FIG. 8, according to an exemplary embodiment.

FIG. 10 is a rear view of the wedge of FIG. 8, according to an exemplary embodiment.

FIG. 11 is a perspective view of a biasing component of the autolock, according to an exemplary embodiment.

FIG. 12 is a perspective view of a biasing component of the autolock, according to another exemplary embodiment.

FIG. 13 is a perspective view of a biasing component of the autolock, according to another exemplary embodiment.

FIG. 14 is side view of a tape measure with a portion of the housing removed, according to another exemplary embodiment.

FIG. 15 is a cross-sectional view of a portion of the braking mechanism of FIG. 14 while a tape blade is being extended, according to an exemplary embodiment.

FIG. 16 is a cross-sectional view of a portion of the braking mechanism of FIG. 14 while a tape blade is being retracted, according to an exemplary embodiment.

FIG. 17 is a perspective view of the cross-sectional view of FIG. 15, according to an exemplary embodiment.

FIG. 18 is a perspective view of a roller for the braking mechanism, according to an exemplary embodiment.

FIG. 19 is a cross-sectional view of the roller taken along line 19-19 of FIG. 18, according to an exemplary embodiment.

FIG. 20 is a side view of a tape measure with a portion of the housing opened, according to another exemplary embodiment.

FIG. 21 is a side view of the tape measure of FIG. 20, according to an exemplary embodiment.

FIG. 22 is a perspective view of the tape measure of FIG. 20 with a portion of the housing removed, according to an exemplary embodiment.

FIG. 23 is a perspective view of a tape measure with a portion of the housing opened, according to another exemplary embodiment.

FIG. 24 is a perspective view of the tape measure of FIG. 23, according to an exemplary embodiment.

FIG. 25 is a perspective view of the tape measure of FIG. 23, according to an exemplary embodiment.

FIG. 26 is a perspective view of a tape measure with a portion of the housing opened, according to another exemplary embodiment.

FIG. 27 is a perspective view of the tape measure of FIG. 26, according to an exemplary embodiment.

FIG. 28 is a perspective view of the tape measure of FIG. 26, according to an exemplary embodiment.

FIG. 29 is a perspective view of a tape measure with a portion of the housing opened, according to another exemplary embodiment.

FIG. 30 is a perspective view of the tape measure of FIG. 29, according to an exemplary embodiment.

FIG. 31 is a perspective view of the tape measure of FIG. 29, according to an exemplary embodiment.

FIG. 32 is a side view of a wedge for a tape measure autolock, according to another exemplary embodiment.

FIG. 33 is a detailed view of the engagement between the wedge of FIG. 32 and a reel in a first position, according to an exemplary embodiment.

FIG. 34 is a detailed view of the engagement between the wedge of FIG. 32 and the reel in a second position, according to an exemplary embodiment.

FIG. 35 is a detailed view of a wedge for a tape measure autolock in a first position, according to another exemplary embodiment.

FIG. 36 is a detailed view of the wedge of FIG. 35 in a second position, according to another exemplary embodiment.

FIG. 37 is a side view of a portion of an autolock tape measure with a portion of the housing open, according to an exemplary embodiment.

FIG. 38 is a side view of the tape measure of FIG. 37 with a wedge in a first position, according to an exemplary embodiment.

FIG. 39 is a side view of the tape measure of FIG. 37 with a wedge in a second position, according to an exemplary embodiment.

FIG. 40 is a side view of the tape measure of FIG. 37 with a wedge in a third position, according to an exemplary embodiment.

FIG. 41 is a front view of a tape port of the tape measure of FIG. 37, according to an exemplary embodiment.

FIG. 42 is a detailed view of an arm of the tape measure of FIG. 37, according to an exemplary embodiment.

FIG. 43 is a detailed view of the autolock mechanism of a tape measure according to an exemplary embodiment.

FIG. 44 is a perspective view of the brake arm of FIG. 43, according to an exemplary embodiment.

FIG. 45 is a perspective view of a brake arm for a tape measure, according to an exemplary embodiment.

FIG. 46 is a side perspective view of the brake arm of FIG. 45, according to an exemplary embodiment.

FIG. 47 is a side view of the brake arm of FIG. 45, according to an exemplary embodiment.

FIG. 48 is a detailed view of a wedge of the autolock mechanism of a tape measure in a first position, according to another exemplary embodiment.

FIG. 49 is a detailed view of the wedge of the autolock mechanism of a tape measure in a second position, according to an exemplary embodiment.

FIG. 50 is a detailed view of the wedge of the autolock mechanism of a tape measure in a third position, according to an exemplary embodiment.

### DETAILED DESCRIPTION

Referring generally to the figures, various embodiments of a tape measure with an automatic locking brake mechanism are shown. As will be generally understood, an auto locking brake mechanism is biased to engage the tape blade and/or tape reel to prevent tape retraction until the brake is disengaged. In various specific embodiments, the brake mechanism includes a wedge type of brake. Unlike conventional wedge brakes, the brakes discussed herein include an engagement or braking surface that includes various angles and/or curvatures configured to engage the tape blade and/or tape reel at different positions along the length of the brake surface. Applicant believes the brakes discussed herein provide for improved braking engagement as the diameter of the spooled tape blade changes as various lengths of the tape blade are extended from the housing. In specific embodiments, the brake includes three engagement zones.

In various embodiments, the tape measure discussed herein includes an improved biasing component design. In contrast to conventional auto locking brake designs where a leaf or “L” shaped cantilever spring is positioned between the braking arm and an interior surface of the housing, the designs discussed herein include one of a cylindrical coil spring, a conical coil spring, and a torsion spring. Applicant believes such biasing components have improved durability and reduced likelihood of buckling. As will generally be understood, such springs are chosen to provide a sufficient force to allow for wedging the tape blade in place without increasing the housing size. Furthermore, Applicant believes the springs discussed herein provide improved endurance and/or life relative to leaf springs that may wear down and/or break. Applicant believes the life cycle improvements occur because components are not overstressed.

Applicant has found using lifecycle testing that a tape measure using the wedge break designs discussed herein have an improved life cycle. In specific embodiments, the tape measure has a tape length of 16 feet has a lifecycle exceeding 5000 cycles. In specific embodiments, the tape measure having a tape length of 25 feet has a lifecycle exceeding 5000 cycles.

Applicant has found a tape measure using a roller design has an improved lifecycle. In specific embodiments, the tape measure has a tape length of 16 feet has a lifecycle exceeding 2500 cycles. In specific embodiments, the tape measure having a tape length of 25 feet has a lifecycle exceeding 5000 cycles. As will be generally understood, the lifecycle testing is conducted by extending the blade (e.g., 108 inches), retracting the blade (e.g., to 24 inches) and letting the brake mechanism engage.

In various embodiments, the locking brake design includes a torsion spring. As will be generally understood, a torsion spring provides a more linear torque during extension of the tape blade compared to other spring types and Applicant therefore believes variability in braking force applied is reduced. Further, Applicant believes torsion springs allow for greater angular displacement within the limited tape measure housing, unlike compression spring. Additionally, Applicant believes the biasing components and system discussed herein improve ergonomics of the tape measure by maintaining a braking force that stops the tape blade in all positions while keeping the actuation force comfortable for a user.

In various embodiments, the braking mechanism includes a roller type brake. Applicant found a roller type brake would emit a loud noise when engaging with the tape blade due to full rotation of the roller. In various embodiments, the roller type brake discussed herein includes a keyed design. In other words, the roller includes a first projection and a second projection to prevent the roller from freely spinning. Applicant believes the roller designs discussed herein includes high or long brake life without emitting noise. In various specific embodiments, the projections are positioned such that the roller can rotate 90 degrees.

In a specific embodiments, brake is a wedge. In such embodiments, the wedge includes an upper contact surface configured to engage the tape blade at or near full extension. In a specific embodiment, the upper contact surface is flat or planar. Applicant believe that such designs allow for improved contact with the blade and also easier release of the blade when the actuator is engaged. In various embodiments, a transition surface from the flat upper surface to a middle portion of the wedge is convex. Applicant believe that such a transition allows the wedge to smoothly pivot out of the wedged/engaged position. In various embodiments, the engagement surface of the wedge has a contact surface that matches the inner diameter of the tape reel.

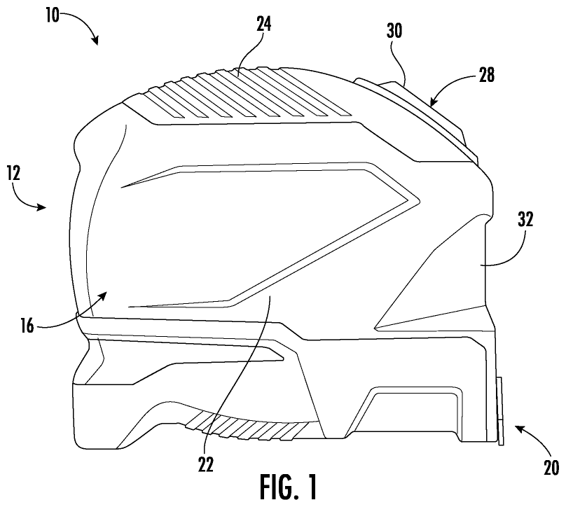

Referring to FIGS. 1-3, a length measurement device, such as a tape measure, shown as an auto locking tape measure 10 is shown according to an exemplary embodiment. Auto locking tape measure 10 includes a coilable tape blade 14 and a housing 12. In general, tape blade 14 is an elongate strip of material including markings. In various embodiments, tape blade 14 extends between 15 and 30 feet. In specific embodiments, tape blade 14 has a length of about 25 ft. In various embodiments, tape blade 14 has a length of about 8 feet, 16 feet or 25 feet. In specific embodiments, tape blade 14 is an elongate strip of metal material (e.g., steel material) that includes an outermost or distal end 44 coupled to a hook assembly, shown as hook assembly 20. In various embodiment, tape blade 14 has a thickness less than a maximum thickness.

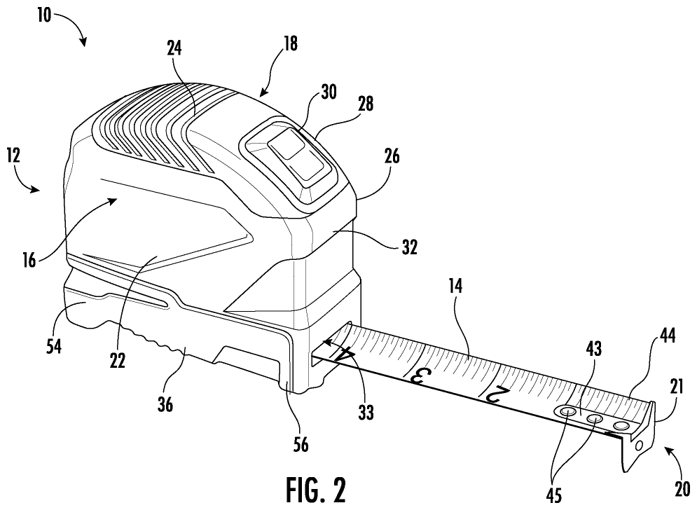

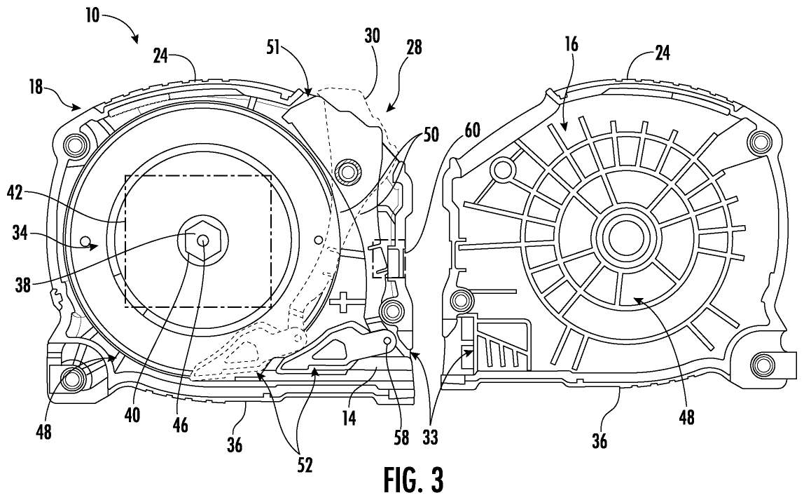

As shown in FIG. 2, a length of the tape blade 14 is extended from housing 12. As shown in FIG. 3, the non-extended portion of tape blade 14 is wound onto or around a reel 34, which is surrounded by housing 12. Reel 34 is rotatably disposed about an axle 40 that defines an axis of rotation 46 of tape measure 10. In specific embodiments, axle 40 is coupled to tape reel 34 by a fastener, shown as nut 38. In various embodiments, axle 40 is coupled to the housing 12 and reel 34 is rotatably mounted within the housing 12 around the axle 40.

Tape measure 10 further includes a retraction mechanism 42, shown schematically. Retraction mechanism 42 is coupled to reel 34 and configured to drive reel 34 about axis of rotation 46 which in turn provides powered retraction of tape blade 14. In specific embodiments, retraction mechanism 42 is positioned at least partially within a portion of reel 34 defined by an interior surface of reel 34. In such an embodiment, interior surface faces and surrounds the axle 40. Retraction mechanism 42 may include one or more springs such as elongated spiral springs, flat springs, etc. that provide the retraction energy to retraction mechanism 42. In various embodiments, retraction mechanism 42 is gearless. In various specific embodiments, retraction mechanism 42 includes a gear powered spring mechanism. In a specific embodiments, the gears are planetary gears.

A brake mechanism, shown as auto locking brake mechanism 28 is provided to selectively engage tape blade 14, which acts to restrain retraction mechanism 42 such that extended segment of tape blade 14 remains at a desired length. As will be generally understood, the auto locking brake mechanism 28 is biased to engage the tape blade 14 and/or tape reel 34 to prevent tape blade 14 retraction until the brake 52 is disengaged. In other words, auto locking brake mechanism 28 will engage tape blade 14 and/or tape reel 34 until a user engages an actuator 30 that moves brake mechanism 28 in a disengaged position.

As will be discussed in greater detail below, auto locking brake mechanism 28 includes actuator 30 connected to a brake arm 50. In various embodiments, actuator 30 is at least partially positioned within housing 12. In specific embodiments, brake arm 50 projects from actuator 30. In specific embodiments, brake arm 50 is integrally formed with actuator 30. Brake arm 50 is coupled to a brake 52. In various specific embodiments, brake 52 is a wedge type brake. In specific embodiments, brake 52 is pivotally coupled to brake arm 50. Brake arm 50 and/or brake 52 are biased by a biasing component 60, shown schematically, into engagement with tape blade 14 and/or tape reel 34. As shown in FIG. 3, auto locking brake mechanism 28 is moveable from a first, engaged position in which brake 52 interfaces against tape reel 34 and/or tape blade 14 into a second disengaged position in which brake 52 is spaced from tape reel 34 and/or tape blade 14.

Referring to FIGS. 1-2, in various embodiments, housing 12 includes a first housing portion 16 and a second housing portion 18 that together enclose an internal cavity (see e.g., 48 in FIG. 3). Housing 12 includes a first side wall 22, a second side wall 26, and a peripheral wall 24 connecting first side wall 22 and second side wall 26. First side wall 22, second side wall 26, and peripheral wall 24 together define the internal cavity 48, in which reel 34 and retraction mechanism 42 are housed. The side walls 22, 26 may be rectangular, polygonal, or any other desired shape. Portions 16, 18 of the housing 12 may be co-molded or separately formed of a resilient material, such as a natural or synthetic rubber. In the illustrated construction, housing 12 is formed with a front support leg 56 which extends from a lower portion of the peripheral wall 24 and a rear support leg 54 that opposes front support leg 56. A bottom wall 36 of housing 12 extends between and connects front support leg 56 to rear support leg 54.

A slot 51, is defined along a forward portion 32 of peripheral wall 24. Slot 51 provides an opening in the tape measure housing 12 which allows brake mechanism 28 to extend into housing 12. In addition, slot 51 provides a length sufficient to allow brake mechanism 28 and more specifically actuator 30 to be moved relative to housing 12 between locked and unlocked positions. Below the slot 51, an opening shown as tape port 33 is provided in peripheral wall 24. Tape port 33 allows for the retraction and extension of tape blade 14 to and from the internal cavity 48 defined within housing 12.

When tape blade 14 is in a retracted position (see e.g., FIG. 1), tape blade 14 is positioned within housing 12. When tape blade 14 is in an extended position (see e.g., FIG. 2), the tape blade 14 extends from housing 12 out of tape port 33. Tape blade 14 and specifically distal end 44 of tape blade 14 is coupled to and/or supports a hook assembly 20. Hook assembly 20 includes a hook 21 coupled to tape blade 14. In specific embodiments, hook 21 is coupled to tape blade 14 via a connection plate 43. In such embodiments, hook 21 is secured to connection plate 43 and/or tape blade 14 by one or more fasteners, shown as rivets 45.

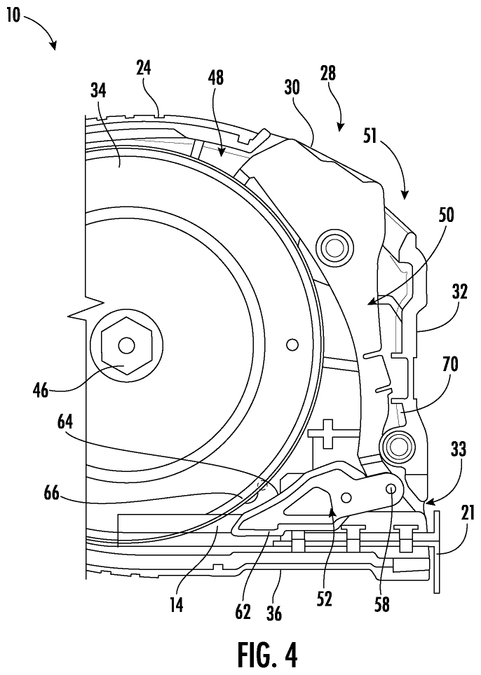

Referring to FIG. 4, details of auto locking brake mechanism 28 in a disengaged and/or unlocked position are shown according to an exemplary embodiment. Tape blade 14 is in a retracted position within housing 12 and therefore brake mechanism 28 is disengaged. In the disengaged position, brake 52 is spaced apart from tape reel 34 and tape blade 14. In various embodiments, when brake mechanism 28 is disengaged, brake arm 50 is positioned along and/or against an interior surface 70 of housing. In specific embodiments, interior surface 70 opposes forward portion 32 of peripheral wall 24.

In various embodiments, brake 52 includes an angled engagement or brake surface 64 and a lower, downward facing surface 62 (in the orientation shown in FIG. 4). Brake surface 64 and lower surface 62 together form a tapered shape. In various embodiments, brake 52 is generally wedge shaped. Brake surface 64 is spaced from outermost portion 66 of tape reel 34 and/or tape blade 14.

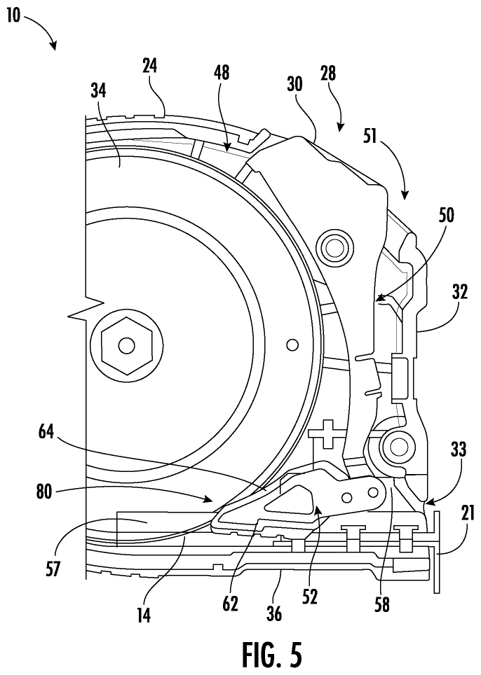

Referring to FIG. 5, details of brake mechanism 28 in a first engaged position are shown according to an exemplary embodiment. As will be discussed in greater detail below, in specific embodiments, brake mechanism 28 includes three engagement positions which correspond to three engagement zones or portions of brake surface 64 of brake 52. As tape blade 14 is moved from a retracted position into the extended position, a first portion or first surface 80 of brake surface 64 interfaces against tape blade 14 and/or reel 34. When tape blade 14 is further extended from housing 12, first surface 80 acts as a wedge against tape blade 14 and/or reel 34 and specifically outermost portion 66 such that tape blade 14 will not retract. In such a position, lower surface 62 of brake 52 extends generally along an upper surface 57 of tape blade 14.

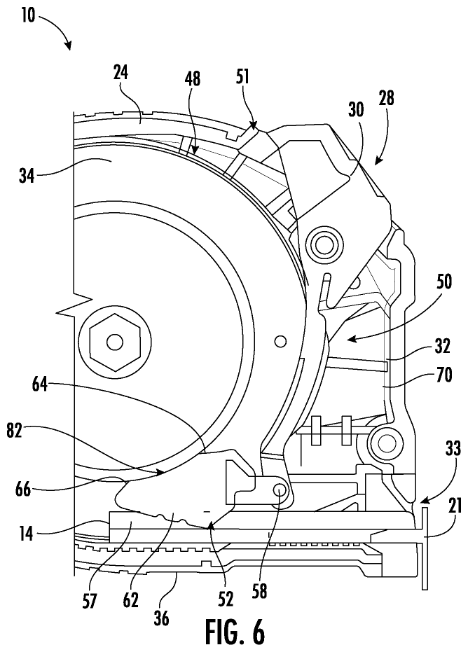

Referring to FIG. 6, details of brake mechanism 28 in a second engaged position are shown according to an exemplary embodiment. As tape blade 14 is moved from the first extended position into a second extended position in which a greater length of tape blade 14 is unwound from reel 34, a second portion or second surface 82 of brake surface 64 interfaces against tape blade 14 and/or reel 34. When tape blade 14 is further extended from housing 12, second surface 82 acts as a wedge against tape blade 14 and/or reel 34 and specifically outermost portion 66 such that tape blade 14 will not retract. In the second engaged position, brake 52 move a greater distance from interior surface 70 than when brake 52 is in the first engaged position. Further, brake 52 pivots about a brake pivot axis 58 into the second engaged position. In such a position, lower surface 62 of brake 52 extends at an angle relative to upper surface 57 of tape blade 14.

As will be discussed in greater detail below, second surface 82 of brake surface 64 has a different angle and/or curvature than first surface 80. In specific embodiments, a size (e.g., width, surface area, etc.) of second surface 82 is different than the size of first surface 80. In specific embodiments, the size (e.g., width, surface area, etc.) of second surface 82 is greater than the size of first surface 80.

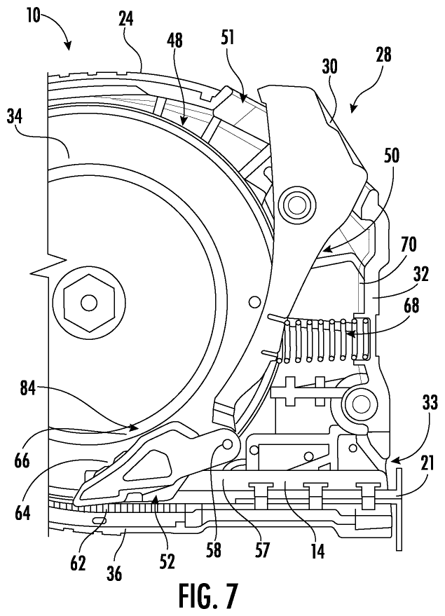

Referring to FIG. 7, details of brake mechanism 28 in a third engaged position are shown according to an exemplary embodiment. As tape blade 14 is moved from the second extended position into a third extended position in which a greater length of tape blade 14 is unwound from reel 34, a third portion or third surface 84 of brake surface 64 interfaces against tape blade 14 and/or reel 34. When tape blade 14 is further extended from housing 12, third surface 84 acts as a wedge against tape blade 14 and/or reel 34 and specifically outermost portion 66 such that tape blade 14 will not retract. In the third engaged position, brake 52 move a greater distance from interior surface 70 than when brake 52 is in the first engaged position or the second engaged position. Further, brake 52 pivots about the brake pivot axis 58 into the third engaged position. In such a position, lower surface 62 of brake 52 extends generally along upper surface 57 of tape blade 14.

As will be discussed in greater detail below, third surface 84 of brake surface 64 has a different angle and/or curvature than first surface 80 and/or second surface 82. In specific embodiments, a size (e.g., width, surface area, etc.) of third surface 84 is different than the size of first surface 80 and second surface 82. In specific embodiments, the size (e.g., width, surface area, etc.) of third surface 84 is greater than the size of first surface 80 and the size of second surface 82.

In specific embodiments, the biasing component is cylindrical spring 68. Cylindrical spring 68 extends between interior surface 70 and brake arm 50. Cylindrical spring 68 biases brake mechanism 28 into engagement with tape blade 14 and/or tape reel 34.

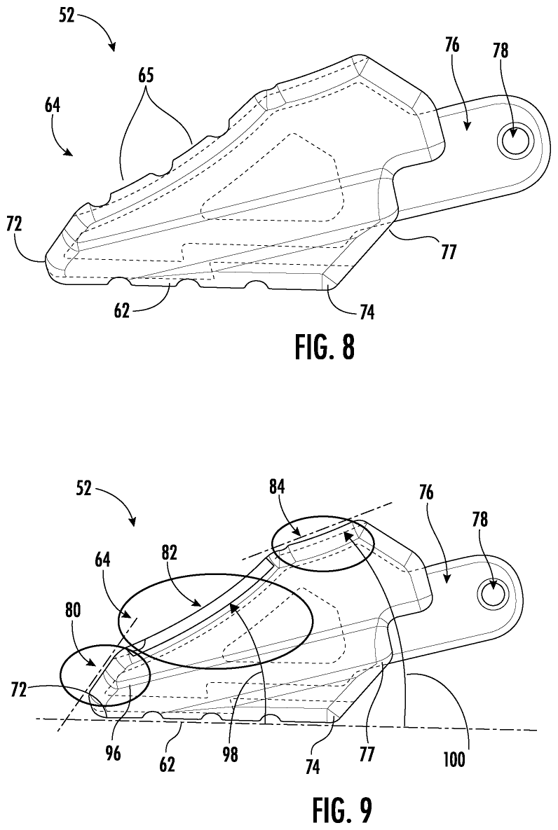

Referring to FIGS. 8-10, details of brake 52 are shown according to an exemplary embodiment. Lower, downward facing surface 62 (in the orientation shown in FIG. 8) of brake 52 extends between and connects a front edge 72 and a rear edge 74. Front edge 72 extends along and connects to first surface 80 of brake surface 64. Rear edge 74 is positioned below (in the orientation shown in FIGS. 8-9) rear projection 76 of brake 52. Rear projection 76 extends from a rear surface 77 of brake 52 and includes bore 78. Bore 78 defines brake pivot axis 58.

In various embodiments, brake 52 is formed from a polymer. In specific embodiments, brake 52 is formed from one of polyvinyl chloride (PVC) rubber, polyurethane, and silicon. In a specific embodiment, brake 52 is formed from PVC rubber and has a Shore A hardness from 70-80. In a specific embodiment, brake 52 is formed from polyurethane and has a Shore A hardness from 55-75. In a specific embodiment, brake 52 is formed from silicon and has a Shore A hardness from 70-80. In various embodiments, the hardness is tested according to ISO 7619-1.

Referring to FIG. 9, details of brake surface 64 are shown according to an exemplary embodiment. In a specific embodiment, brake surface 64 includes first surface 80, second surface 82, and third surface 84. The second surface 82 is positioned between the first surface 80 and the third surface 84. In various embodiments, brake surface 64 includes one or more ribs 65 positioned at various points along brake surface 64. Applicant believes ribs 65 allow debris and/or contaminants to enter the rib structure preventing failure of the brake 52. Further, ribs 65 allow for improved contact surface area and dimensional accuracy on brake 52 overmold.

As previously discussed, Applicant believes the brake 52 discussed herein provides for improved braking engagement as the diameter of the spooled tape blade 14 changes as various lengths of the tape blade 14 are extended from the housing 12. For example, in various embodiments, first surface 80 has a relatively steep angle configured to engage with tape reel 34 and/or tape blade 14 when a large portion of tape blade 14 is still wound around tape reel 34. In various embodiments, second surface 82 has an intermediate angle configured to engage tape reel 34 and/or tape blade 14 when more of the length of tape blade 14 has been unwound from tape reel 34. In various embodiments, third surface 84 has a shallower angle compared to first surface 80 and second surface 82 and is configured to engage with tape reel 34 and/or tape blade 14 when a large portion of the length of tape blade 14 has been extended or unwound from tape reel 34.

In specific embodiments, first surface 80 has a first radius of curvature, second surface 82 has a second radius of curvature, and third surface 84 has a third radius of curvature. In various embodiments, the first radius of curvature is different than the second radius of curvature and the third radius of curvature. In a specific embodiment, first surface 80 has a first angle 96 defined between lower surface 62 and a tangent line of first surface 80. In a specific embodiment, second surface 82 has a second angle 98 defined between lower surface 62 and a tangent line of second surface 82. As will be generally understood, the first angle 96 allows for brake 52 to move into a self-energizing position while allowing for ease of removal of brake 52 from the locked position when the actuator 30 is engaged. The second angle 98 is configured to follow a spooled diameter of tape blade 14.

In a specific embodiment, third surface 84 has a third angle 100 defined between lower surface 62 and a tangent line of third surface 84. As will be generally understood, the third angle 100 allows brake 52 to move or pivot into a deeper locking position. In other words, the third surface 62 and/or third angle 100 allows brake 52 to continue to engage the spooled diameter of tape blade 14 after such a diameter has changed. In various specific embodiments, the first angle 96 is different than the second angle 98 and the third angle 100. In various specific embodiments, the first angle 96 is greater than the second angle 98 and the third angle 100. In various specific embodiments, the second angle 98 is less than the first angle 96 and greater than the third angle 100. In a specific embodiment, the third angle 100 is less than the first angle 96 and the second angle 98.

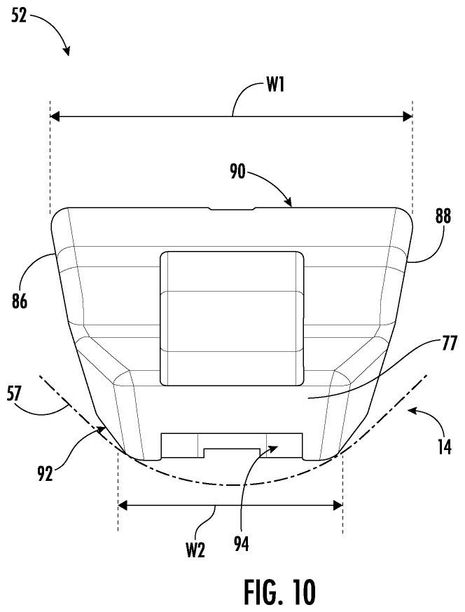

Referring to FIG. 10, a rear view of brake 52 is shown according to an exemplary embodiment. Brake 52 further includes a top edge 90 defined along third surface 84. Brake 52 includes a pair of bottom edges 92 that extend between and connect front edge 72 and rear edge 74. Bottom edges 92 each extend along a respective side surface 86, 88 of brake 52.

In various embodiments, brake 52 has a first width, W1, defined by top edge 90. The first width extends between opposing side surface 86, 88 along an uppermost point of brake 52 (e.g., along third surface 84).

In various embodiments, brake 52 has a second width, W2, defined by opposing bottom edges 92 and along rear surface 77. In specific embodiments, W2 is different than W1. In specific embodiments, W1 is greater than W2. Applicant believes a wider third surface 84 of brake surface 64 provides for improved engagement with spooled tape blade surface 57. Further, the narrower second width allows brake 52 to engage with upper surface 57 and the blade curvature of tape blade 14.

In various embodiments, rear surface 77 includes recessed or cutout portion 94. The recessed portion 94 provides space for hook assembly 20 and in particular for hook 21 and connection plate 43.

Referring to FIG. 11, a detailed view of a biasing component, shown as a compression spring, shown as a cylindrical compression spring 68 is shown according to an exemplary embodiment. In various specific embodiments, the cylindrical spring 68 is a cylindrical compression spring. Cylindrical spring 68 can be utilized with brake mechanism 28. Cylindrical spring 68 extends between a first end 102 and an opposing second end 104. In various embodiments, first end 102 interfaces against an interior surface of housing 12 and second end engages the brake arm 50. When assembled as part of the tape measure 10, compression spring 68 biases the brake 52 into engagement with the tape blade 14 to resist retraction of the tape blade 14.

In various embodiments, first end 102 has a first diameter and second end 104 has a second diameter. In a specific embodiment, first diameter is the same as second diameter. When cylindrical spring 68 is utilized with brake mechanism 28, first end 102 is received and/or engaged by interior surface 70 of housing 12 and second end 104 is engaged with brake arm 50. Applicant believes cylindrical spring 68 provides for improved engagement of the brake mechanism 28 compared to a conventional leaf spring.

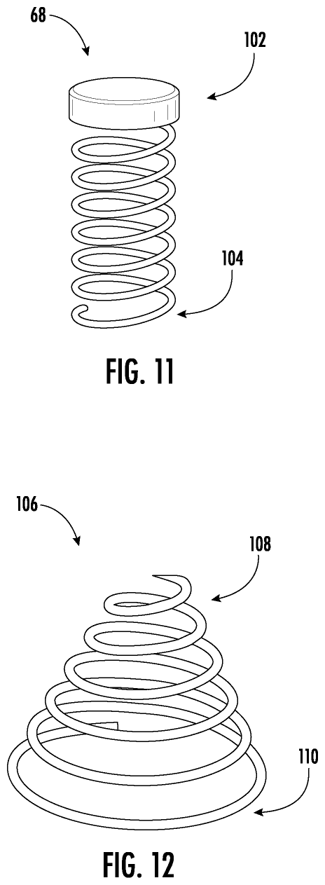

Referring to FIG. 12, a detailed view of a biasing component, shown as a conical spring 106 is shown according to an exemplary embodiment. In various specific embodiments, the conical spring 106 is a conical compression spring. Conical spring 106 can be utilized with brake mechanism 28. Conical spring 106 extends between a first end 108 and an opposing second end 110. In various embodiments, first end 108 has a first diameter and second end 110 has a second diameter. In a specific embodiment, first diameter is different than the second diameter. In a specific embodiment, first diameter is less than second diameter.

When conical spring 106 is utilized with brake mechanism 28, an end with a larger diameter is received and/or engaged by interior surface 70 of housing 12 and the opposing smaller diameter end is engaged with brake arm 50. Engagement between the smaller diameter end and brake arm 50 controls the contact point with the brake arm 50 and allows increased flexibility of spring 106 as brake arm 50 rotates. As will be generally understood, conical spring 106 allows the coil springs to compress onto each other and therefore save space within the compact housing 12 dimensions. Further, conical springs 106 allow for a nonlinear push force on actuator 30. In other words, a force increases as a user depresses actuator 30 further.

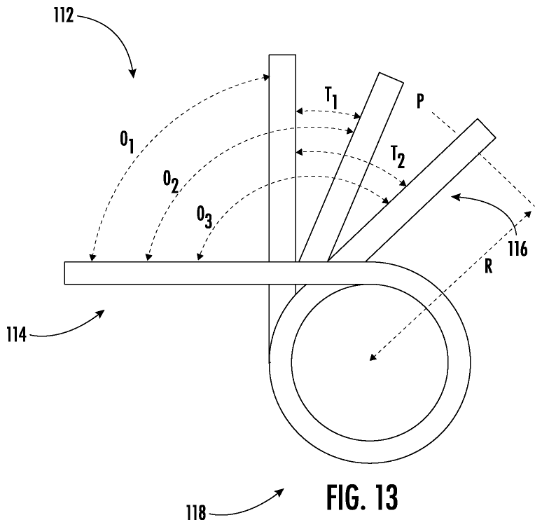

Referring to FIG. 13, a detailed view of a biasing component, shown as a torsion spring 112 is shown according to an exemplary embodiment. As previously discussed, Applicant believes use of a torsion spring 112 provide improved endurance and/or life of the tape measure. In various embodiments, the torsion spring 112 supports an operational life greater than 1 million cycles by using a chosen wire diameter and body coil number to reduce fatigue while fitting within the size constraints of the tape measure housing.

Torsion spring 112 can be utilized with brake mechanism 28. Torsion spring 112 includes a first leg 114 that extends from body 118 in a first direction. Torsion spring 112 further includes a second leg 116 that extends from body 118 in a second direction. In specific embodiments, second direction is different than first direction.

In various embodiments, torsion spring 112 has a wire diameter of about 1.3 mm (e.g., 1.3 mm plus or minus 0.1 mm). In various embodiments, torsion spring 112 has a coil outer diameter of about 10.87 mm (e.g., 10.87 mm plus or minus 1.09 mm). In various specific embodiments, torsion spring 112 has a number of body coils between 5 and 10 turns, specifically between 6 and 9 turns, and more specifically between 7 and 9 turns. In a specific embodiment, torsion spring has about 8.78 turns. In a specific embodiment, torsion spring 112 is formed from music wire.

In various embodiments, body 118 has a length of about 12.71 mm (e.g., 12.71 mm plus or minus 1.3 mm). In various specific embodiments, torsion spring 112 has a spring rate of 1.7376 N-mm/degrees. In various embodiments, an angle between first leg 114 and second leg 116 is about 260 degrees. In various embodiments, torsion spring 112 has an operational range of 117 degrees to 143 degrees.

Applicant believe that torsion springs 112 as discussed herein will have a 248 N-mm torque as blade 14 is retracted. In such embodiments, a thumb force (i.e., force on actuator 30) is about 2.6 lbf. In various embodiments, torsion springs 112 as discussed herein will have a 203 N-mm torque as blade 14 is extended. In such embodiments, a braking force is about 1.1 lbf. As will be understood, the braking force is a wedging force or the force required to restrict the blade from retracting into the housing. The wedging force is provided by the spring (e.g., torsional, conical spring, etc.).

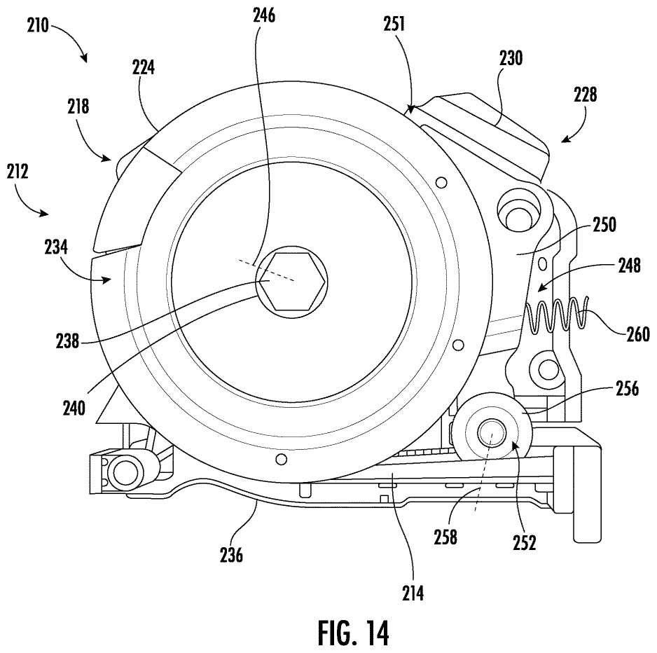

Referring to FIGS. 14-19, details of a tape measure 210 with a brake mechanism, shown as auto locking brake mechanism 228 are shown according to another exemplary embodiment. Tape measure 210 is substantially the same as tape measure 10 except for the differences discussed herein. Brake mechanism 228 is substantially the same as brake mechanism 28 except for the differences discussed herein.

Referring to FIGS. 14-17, details of brake mechanism 228 are shown according to an exemplary embodiment. In various embodiments, auto locking brake mechanism 228 includes actuator 230 connected to a brake arm 250. In specific embodiments, brake arm 250 projects from actuator 230. In specific embodiments, brake arm 250 is integrally formed with actuator 230. Brake arm 250 is coupled to a brake 252. In various specific embodiments, brake 252 is a wedge type brake.

In various embodiments, brake arm 250 includes an engagement portion 254 coupled to brake 252. Engagement portion 254 is positioned on an opposing end of brake arm 250 from actuator 230. In specific embodiments, engagement portion 254 is U-shaped. In various embodiments, engagement portion 254 has a first leg 270 and a second leg 274 that is spaced from first leg 270. First leg 270 includes an inner surface 272 that faces second leg 274. Similarly, second leg 274 includes an inner surface 276 that faces first leg 270.

In various embodiments, brake 252 includes a roller 256 with an outer surface 262 that engages tape blade 214 and/or reel 234. In various embodiments, brake 252 includes at least one roller 256 with an outer surface 262 that engages tape blade 214 and/or reel 234. Roller 256 is coupled to a shaft 264 that is rotatably coupled to engagement portion 254 of brake arm 250. In specific embodiments, shaft 264 is positioned between first leg 270 and second leg 274 of brake arm 250. Brake 252 and specifically shaft 264 includes a first projection 266 and a second projection 268. The first projection 266 and second projection 268 each extend radially outward from shaft 264. In other words, first projection is a first radial projection 266 and second projection is a second radial projection 268. In various embodiments, first projection 266 extends away from the axis of rotation 258 of the shaft 264 and the second projection 268 extends away from the axis of rotation 258 of the shaft 264.

As previously discussed, Applicant found a freely rotating brake created a loud noise when the brake engaged with the tape blade. In contrast, brake 252 is not freely rotating. In various embodiments, when the first radial projection 266 or the second radial projection 268 of the shaft 264 interface against the brake arm 250, the first radial projection 266 or the second radial projection 268 resist rotation of the roller 256 such that the roller 256 is not freely rotating. In other words, both the first radial projection 266 and the second radial projection 268 resist rotation of the roller 256 such that the roller 256 is not freely rotating when the respective radial projection 266, 268 engages the brake arm 250 or the engagement portion 254 of the brake arm 250. As will be generally understood, first projection 266 and second projection 268 prevent the brake 252 from freely rotating. In specific embodiments, brake 252 and/or roller 256 can rotate 90 degrees. In various specific embodiments, brake 252 is configured to rotate 90 degrees or less. in other embodiments, brake 252 is configured to rotate 180 degrees or less.

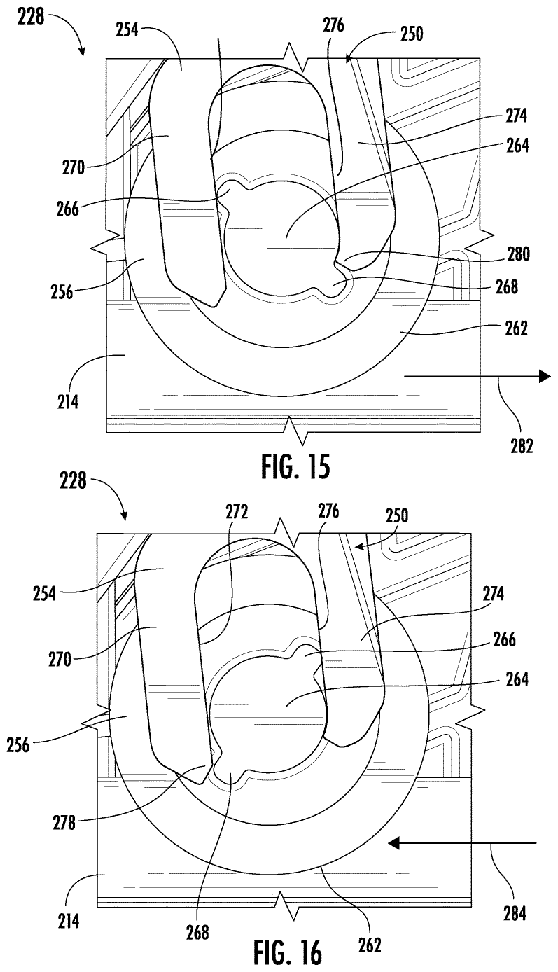

As shown in FIG. 15, when tape blade 214 is moving in an extension direction, shown by arrow 282, first projection 266 and second projection 268 engage first leg 270 and second leg 274 respectively to stop the rotation of brake 252. In specific embodiments, first projection 266 engages inner surface 272 of first leg 270 and second projection 268 engages an end, shown as distal end 280 of second leg 274.

As shown in FIG. 16, when tape blade 214 is moving in a retraction direction, shown by arrow 284, first projection 266 and second projection 268 engage first leg 270 and second leg 274 respectively to stop the rotation of brake 252. In specific embodiments, first projection 266 an end, shown as distal end 278 of first leg 270 and second projection 268 engages inner surface 276 of second leg 274. When first projection 266 engages first leg 270, an outer surface 286 of first projection 266 interfaces against first leg 270 such that brake 252 resists movement. When second projection 268 engages second leg 274, an outer surface 288 of second projection 268 interfaces against second leg 274 such that brake 252 resists movement. In other words, first projection 266 and/or second projection 268 act as a mechanical stop for rotation of roller 256.

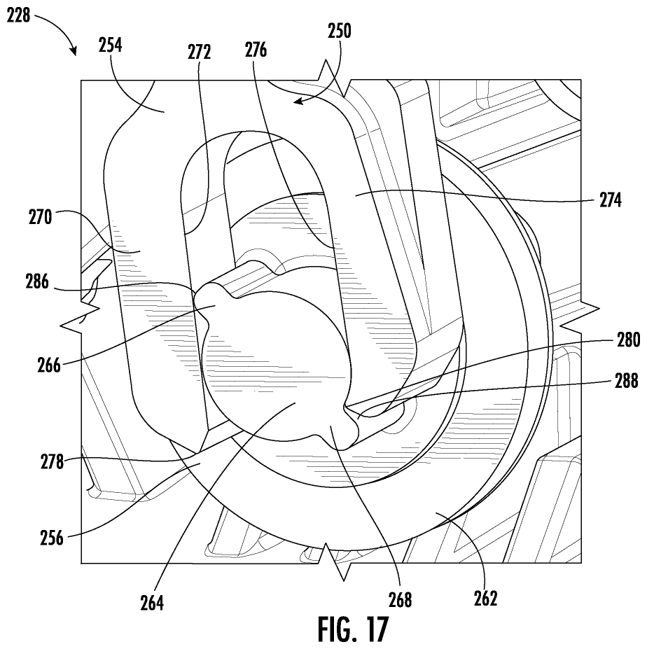

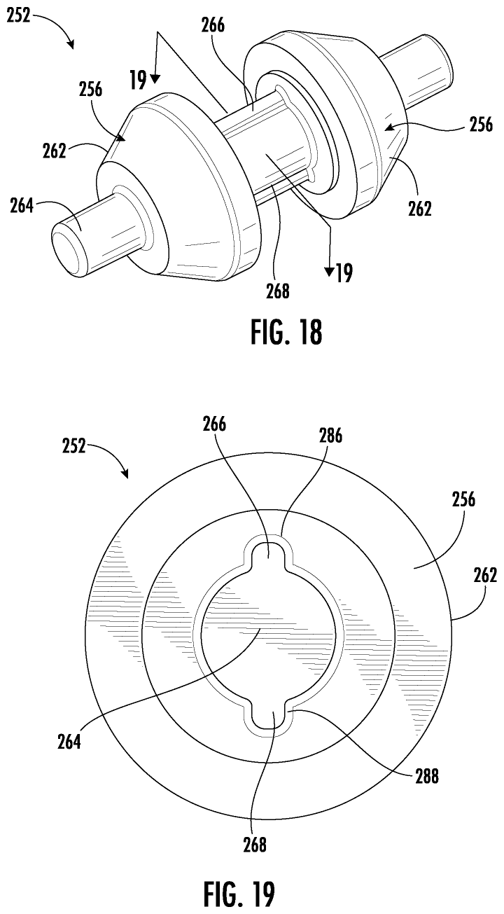

Referring to FIGS. 18-19, details of brake 252 are shown according to an exemplary embodiment. As shown in FIG. 18, in various specific embodiments, brake 252 includes first and second rollers 256 spaced along a length of shaft 264. In specific embodiments, each roller 256 has a generally frustoconical shape. In other embodiments, roller 256 may have a different shape (e.g., cylindrical, etc.). In specific embodiments, first projection 266 and second projection 268 are pin molded. In various embodiments, first projection 266 and second projection 268 extend radially outward from shaft 264 along a length of shaft 264 positioned between first roller 256 and second roller 256. In specific embodiments, the first projection 266 and second projection 268 are diametrically opposed. In other words, the first projection 266 is spaced apart from the second projection 268 around the circumference of the shaft.

As will be generally understood, engagement portion 254 and in particular first leg 270 and second leg 274 are configured to engage shaft 264 between the first roller 256 and the second roller 256.

Applicant believes the limited rotation of roller(s) 256 allows brake 252 to self-energize during retraction of tape blade 214. In specific embodiments, brake 252 is energized after 20 degrees of rotation. Further, first projection 266 and second projection 268 allow for brake 252 to be assembled in multiple directions.

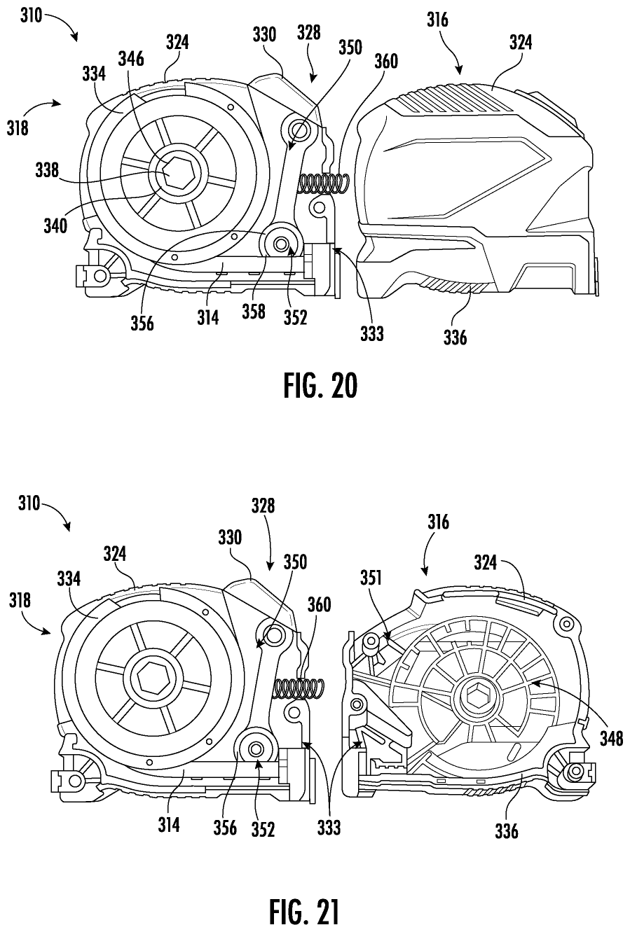

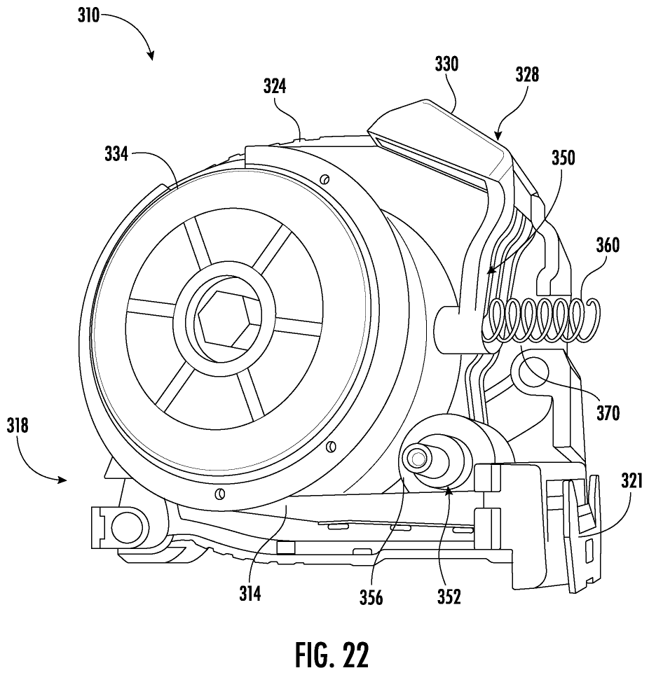

Referring to FIGS. 20-22, details of a tape measure 310 are shown according to an exemplary embodiment. Tape measure 310 is substantially the same as tape measures 10, 210 except for the differences discussed herein.

Tape measure 310 includes an auto locking brake mechanism 328. Brake mechanism 328 includes an actuator 330 connected to a brake arm 350. In specific embodiments, brake arm 350 projects from actuator 330. In various specific embodiments, brake 352 includes a roller 356. In one or more embodiments, roller brake 252 can be utilized with tape measure 310. Brake mechanism 328 further includes a biasing component, shown as a cylindrical spring 360.

Cylindrical spring 360 extends between and engages interior surface 370 of housing 312 and an opposing end is engaged with brake arm 350. In one or more specific embodiments, an end of spring 360 is at least received within brake arm 350. In one or more specific embodiments, tape blade 314 has a length of about 16 ft.

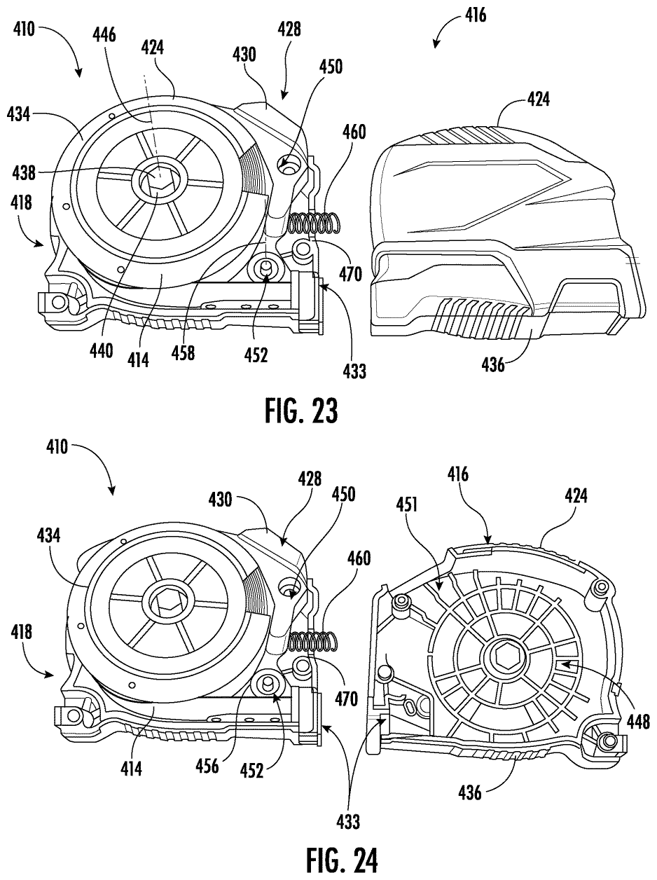

Referring to FIGS. 23-25, details of a tape measure 410 are shown according to an exemplary embodiment. Tape measure 410 is substantially the same as tape measures 10, 210, 310 except for the differences discussed herein.

Tape measure 410 includes an auto locking brake mechanism 428. Brake mechanism 428 includes an actuator 430 extending from a brake arm 450. In various specific embodiments, brake 452 includes a roller 456. In one or more embodiments, roller brake 252 can be utilized with tape measure 410. Brake mechanism 428 further includes a biasing component, shown as a cylindrical spring 460. Cylindrical spring 460 extends between and engages interior surface 470 of housing 412 and an opposing end is engaged with brake arm 450. In one or more specific embodiments, tape blade 414 has a length of about 25 ft.

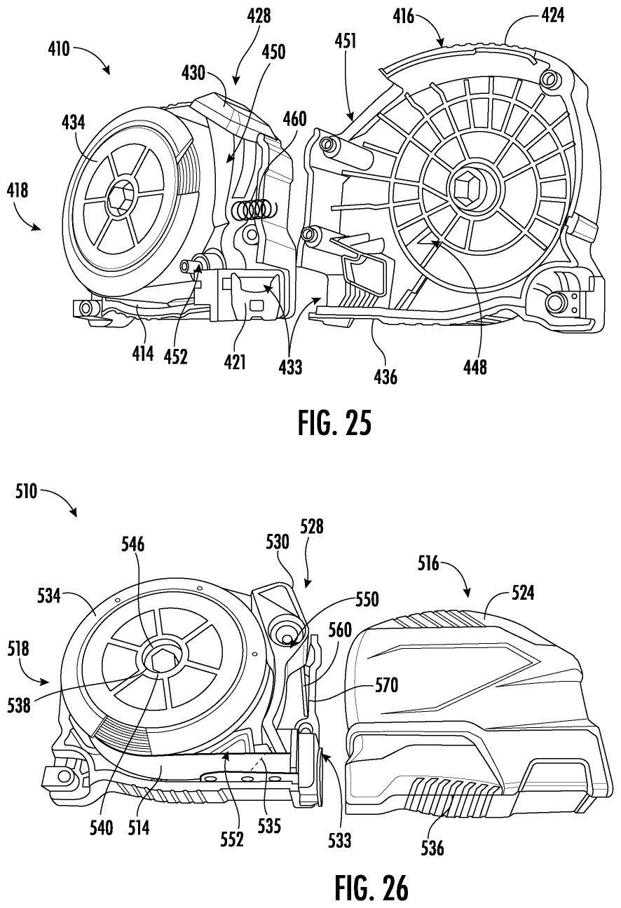

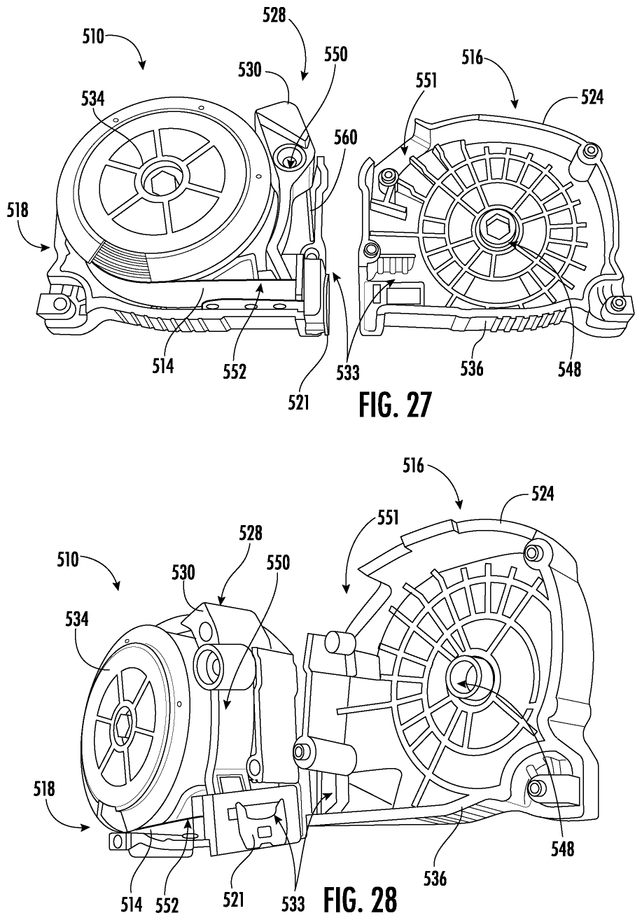

Referring to FIGS. 26-28, details of a tape measure 510 are shown according to an exemplary embodiment. Tape measure 510 is substantially the same as tape measures 10, 210, 310, 410 except for the differences discussed herein.

Tape measure 510 includes an auto locking brake mechanism 528. Brake mechanism 528 includes an actuator 530 extending from a brake arm 550. In various specific embodiments, brake 552 has a wedge shape. In one or more embodiments, wedge brake 52 can be utilized with tape measure 510. Brake mechanism 528 further includes a biasing component, shown as a torsion spring 560. Torsion spring 560 extends between and engages interior surface 570 of housing 512 and an opposing end is engaged with brake arm 550. In one or more specific embodiments, a first leg of torsion spring 560 engages brake arm 550 and a second arm engages interior surface 570. In one or more specific embodiments, tape blade 514 has a length of about 25 ft.

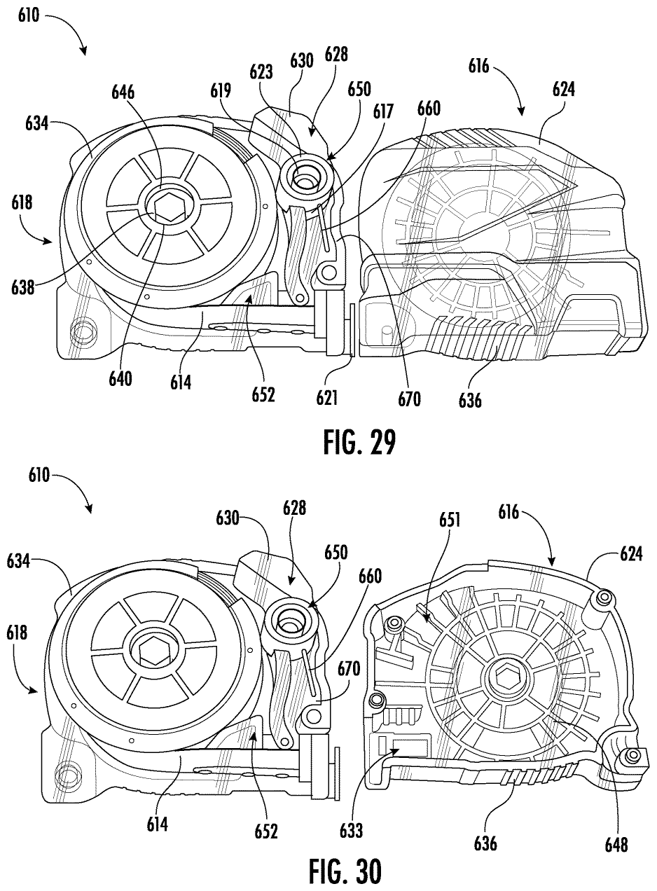

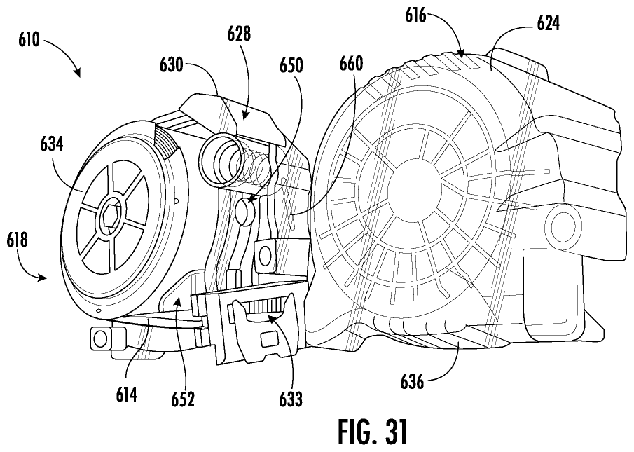

Referring to FIGS. 29-31, details of a tape measure 610 are shown according to an exemplary embodiment. Tape measure 610 is substantially the same as tape measures 10, 210, 310, 410, 510 except for the differences discussed herein.

Tape measure 610 includes an auto locking brake mechanism 628. Brake mechanism 628 includes an actuator 630 extending from a brake arm 650. In various specific embodiments, brake 652 has a wedge shape. In one or more embodiments, wedge brake 52 can be utilized with tape measure 610. Brake mechanism 628 further includes a biasing component, shown as a torsion spring 660. Torsion spring 660 extends between and engages interior surface 670 of housing 612 and an opposing end is engaged with brake arm 650. Torsion spring 660 includes a first leg 617 that extends from body 619 in a first direction. Torsion spring 660 further includes a second leg 623 that extends from body 619 in a second direction. In specific embodiments, second direction is different than first direction.

In one or more specific embodiments, a first leg 617 of torsion spring 660 engages interior surface 670 and second leg 623 engages brake arm 650. In one or more specific embodiments, body 619 is at least partially received within brake arm 650. In one or more specific embodiments, tape blade 614 has a length of about 16 ft.

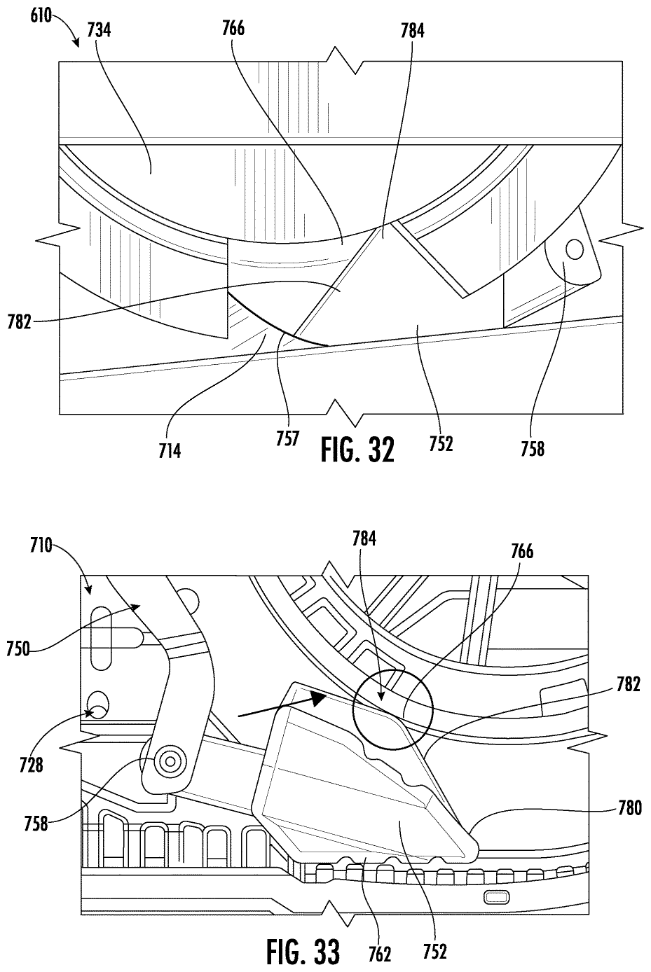

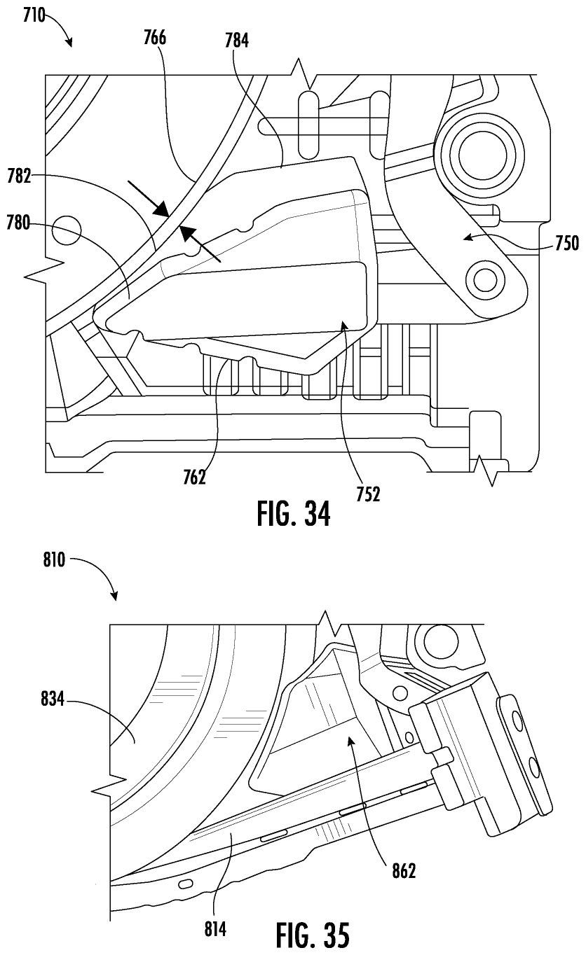

Referring to FIGS. 32-34, details of a wedge brake 752 that can be utilized with a tape measure 710 are shown according to an exemplary embodiment. Tape measure 710 is substantially the same as tape measures 10, 210, 310, 410, 510, 610 except for the differences discussed herein.

Tape measure 710 includes an auto locking brake mechanism 728. Brake mechanism 728 includes an actuator (see e.g., 630) extending from a brake arm 750. In specific embodiments, a brake 752 is engaged with brake arm 750. In various specific embodiments, brake 752 has a wedge shape. Brake 752 pivots about a brake pivot axis 758 into different engagement positions with reel 734 and/or tape blade 714 as tape blade 814 is extended and/or retracted.

In specific embodiments, brake 752 includes projecting wall or fin that provides an upper contact surface 784 configured to engage the tape blade 714 at or near full extension. In one or more embodiments, brake 752 includes upper contact surface 784, middle contact surface 782 and lower contact surface 780. In a specific embodiment, the upper contact surface 784 is flat or planar. A transition from the planar portion to the middle contact surface 783 is convex to allow for smooth pivoting of brake 752.

As shown in FIG. 32, lower surface 762 of brake 752 extends engages an upper surface 757 of tape blade 714. An upper engagement surface 784 of wedge engages tape blade 714 or more specifically spooled portion 766 of tape blade 714. Applicant believes the shape of brake 752 allows for the brake 752 to move further inward toward reel 734.

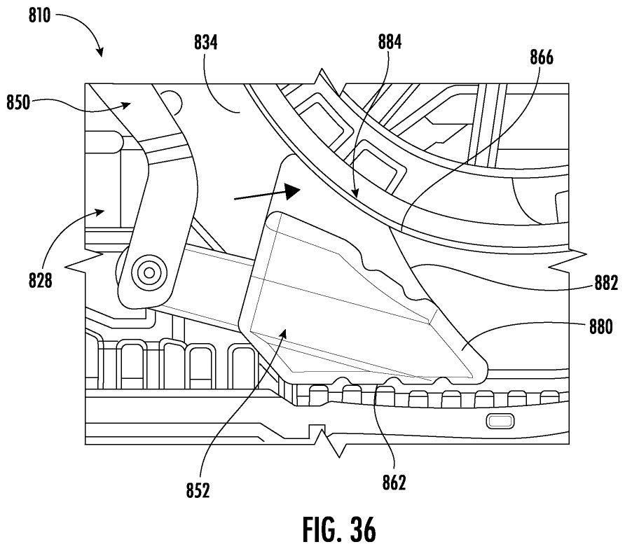

Referring to FIGS. 35-36, details of a wedge brake 852 that can be utilized with a tape measure 810 are shown according to an exemplary embodiment. Tape measure 810 is substantially the same as tape measures 10, 210, 310, 410, 510, 610, 710 except for the differences discussed herein.

Tape measure 810 includes an auto locking brake mechanism 828. Brake mechanism 828 includes an actuator (see e.g., 630) extending from. In various specific embodiments, brake 852 has a wedge shape. Brake 852 pivots about a brake pivot axis into different engagement positions with reel 834 and/or tape blade 814 as tape blade 814 is extended and/or retracted. In one or more embodiments, brake 852 includes upper contact surface 884, middle contact surface 882 and lower contact surface 880.

Applicant has found the shape of brake 852 improves both pushing into and/or engaging tape blade 814 and releasing blade 814 more easily when the actuator is pressed. As shown in FIG. 36, upper contact surface 884 matches the inner diameter of reel 834. In such embodiments, the inner diameter of the spool is defined by a radially outward facing surface that blade 814 is wound around. As shown in FIG. 35, when blade 814 is not extended at all (i.e., zero extension), middle contact surface 882 matches an outer diameter defined by the spooled blade 814.

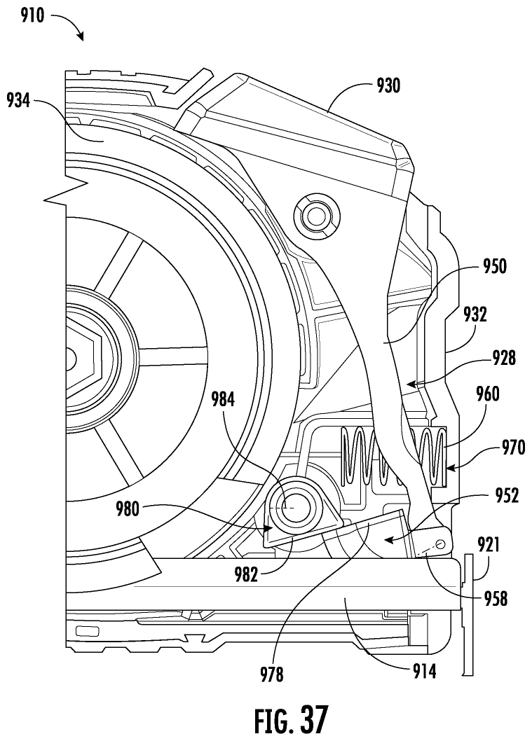

Referring to FIGS. 37-42, details of a tape measure 910 are shown according to another exemplary embodiment. Tape measure 910 is substantially the same as tape measures 10, 210, 310, 410, 510, 610, 710 except for the differences discussed herein.

Tape measure 910 includes an auto locking brake mechanism 928. In various embodiments, brake mechanism 928 includes an actuator 930 extending from a brake arm 950. In specific embodiments, a brake 952 is engaged with brake arm 950. In various specific embodiments, brake 952 has a wedge shape. In specific embodiments, brake 952 is pivotally coupled to brake arm 950.

As will be generally understood, for brake mechanisms that engage the tape blade, as the tape blade extends, a diameter of the spooled blade decreases. As such, the range or angle across which the brake arm moves must increase in order to continue engaging with the tape blade. Applicant has found that such an arrangement creates an ergonomic problem for users who are forced to pull the actuator or button backwards instead of pushing downward as intended for autolock tape measures. As such, Applicant believes reducing the range of motion of the brake arm to be smaller than a typical brake arm which can move more than 30 degrees, provides the desired brake engagement without the ergonomic button engagement problems. As will be discussed in greater detail below, in specific embodiments, the brake engages a feature (fixed or rotational) within the housing to reduce the range of motion of the brake arm. In specific embodiments, the range of motion of the brake arm is less than 30 degrees.

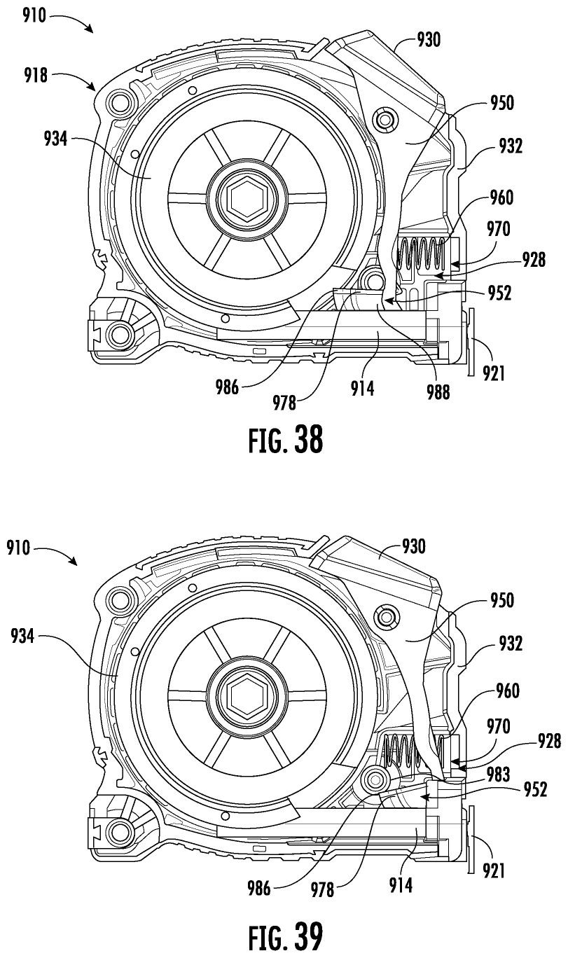

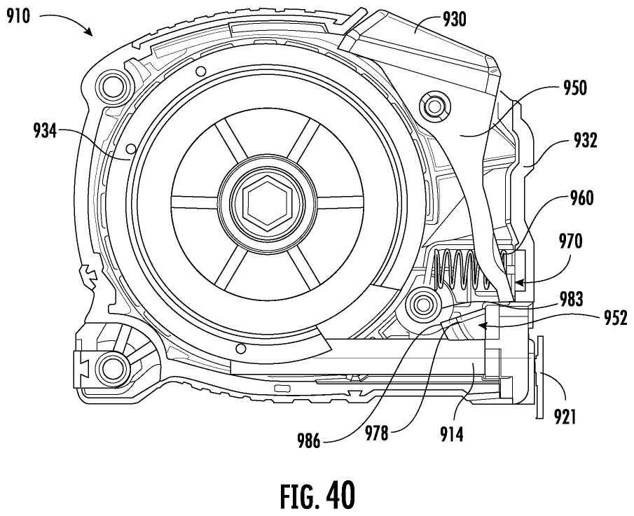

Referring to FIGS. 37-38, brake 952 pivots about a brake pivot axis 958 into different engagement positions with housing 912 and/or a structure coupled to portion of housing 918. In specific embodiments, brake 952 engages or acts as a wedge with a feature on housing 912 such as ramp 980 and/or a housing engagement structure, shown as a housing protrusion or protruding cylinder 983. In various specific embodiments, protruding cylinder 983 is a screw boss (see e.g., FIG. 39). In other embodiments, the protruding cylinder 983 may have a different geometry (e.g., rectangular, triangular, etc.). In various specific embodiments, ramp 980 is freely rotating about an axis 984. Applicant believes the rotation of the ramp 980 improves performance of the brake mechanism 928 over the life of tape measure 910. In other specific embodiments, screw boss 983 is fixed.

In various embodiments, brake 952 is connected to brake arm 950 directly via a pin. In other embodiments, brake 952 is coupled to brake arm 950 by a subassembly with a connection pin. In specific embodiments, brake arm 950 and/or brake 952 are biased by a biasing component 960, shown as a cylindrical spring. In specific embodiments, cylindrical spring is a cylindrical compression spring. In other embodiments, biasing component 960 is a torsional spring. In various embodiments, when brake mechanism 928 is disengaged, brake arm 950 is positioned along and/or against an interior surface 970 of housing. In specific embodiments, interior surface 970 opposes forward portion 932 of peripheral wall 924. In specific embodiments, interior surface 970 includes a recess that receives and supports biasing component 960.

When assembled as part of the tape measure 910, compression spring 960 biases the brake 952 into engagement with the tape blade 914 and/or ramp 980, protruding cylinder 983 to resist retraction of the tape blade 914. When brake 952 interfaces against surface 982 of ramp 980 or protruding cylinder 983, the engagement resists further movement of brake arm 950 toward reel 934 preventing the excess angular movement of actuator 930.

Referring to FIGS. 38-40, details of brake mechanism 928 are shown according to an exemplary embodiment. In such an embodiment, brake mechanism 928 includes protruding cylinder 983. As shown in FIG. 38, brake 952 includes a first end 986 and a second end 988 opposite the first end 986. Brake 952 includes an upper surface 978 that faces protruding cylinder 983. In various embodiments, upper surface 978 is an angled surface. In other words, brake 952 has a tapered shape. When brake 952 is in a wedged position, upper surface 978 engages protruding cylinder 983 while an opposing lower surface 953 engages tape blade 914 to resist retraction of tape blade 914. FIG. 38 shows brake 952 in a fully wedged position against tape blade 914 and protruding cylinder 983 and/or reel 934.

Referring to FIG. 39, brake 952 is shown in a second position, according to an exemplary embodiment. In the second position, first end 986 has moved into engagement with an exterior or outward facing surface of protruding cylinder 983. Referring to FIG. 40, brake 952 is shown in a third position, according to an exemplary embodiment, brake 952 is in a disengaged position. In other words, first end 986 and upper surface 978 are spaced from protruding cylinder 983 or ramp 980. As such, brake arm 950 is still able to move toward reel 934.

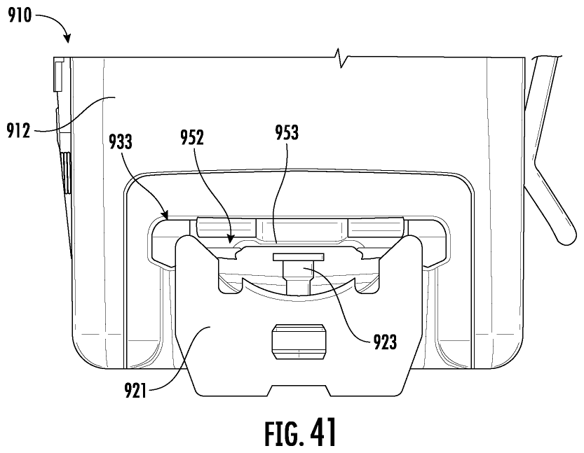

Referring to FIG. 41, details of an opening shown as tape port 933 that is provided in peripheral wall 932 are shown according to an exemplary embodiment. Tape port 933 allows for the retraction and extension of tape blade 914 to and from the internal cavity defined within housing 912. In various embodiments, a hook 921 is coupled to tape blade 914 via a connection plate. In such embodiments, hook 21 is secured by one or more fasteners, shown as rivets 923. In various embodiments, lower surface 953 of brake 952 has a recessed portion to provide clearance from rivet 923. In other words, lower surface 953 of brake 952 is spaced apart from hook 921 and/or rivet 923.

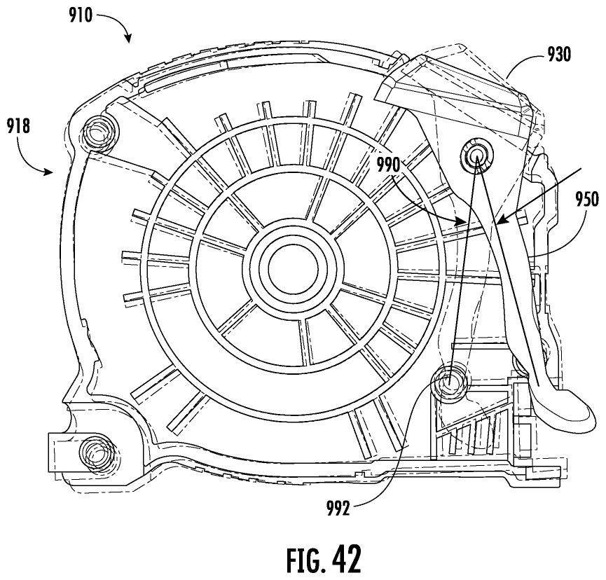

Referring to FIG. 42, details of the range of motion of the brake mechanism 928 and in particular brake arm 950 are shown according to an exemplary embodiment. As showing in FIG. 42, brake arm 950 is moveable between a first position (i.e., solid line brake arm 950) in which brake mechanism 928 is disengaged to a second position (i.e., broken line brake arm 950) in which brake mechanism 928 is engaged such as with screw boss 983 and/or ramp 980. In various embodiments, the angular motion of brake arm 950 is defined as movement of the longitudinal axis of brake arm 950 between the first position and the second position.

In various embodiments, an angle 990 is defined between the first position and the second position. In specific embodiments, the range of motion or movement of the brake arm 950 between the first position and the second position is less than 30 degrees, specifically less than 25 degrees, and more specifically less than 20 degrees. In a specific embodiment, the brake arm 950 range of motion is about 15 degrees (e.g., 15 degrees plus or minus 3 degrees).

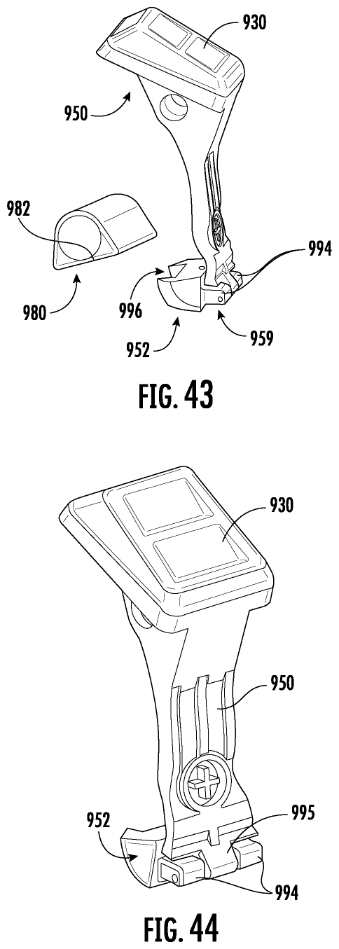

Referring to FIGS. 43-44, details of brake mechanism 928 are shown according to an exemplary embodiment. In specific embodiments, brake 952 includes a recessed portion 966 at first end 986. In various specific embodiments, brake 952 includes one or more prongs 944 that are couplable to brake arm 950. In specific embodiments, second end 988 of brake 952 includes two prongs 944. In such embodiments, respective prongs 944 are positioned on opposing sides of a connector 955 of brake arm 950. In specific embodiments, prongs 944 are coupled to connector 955 via a pin.

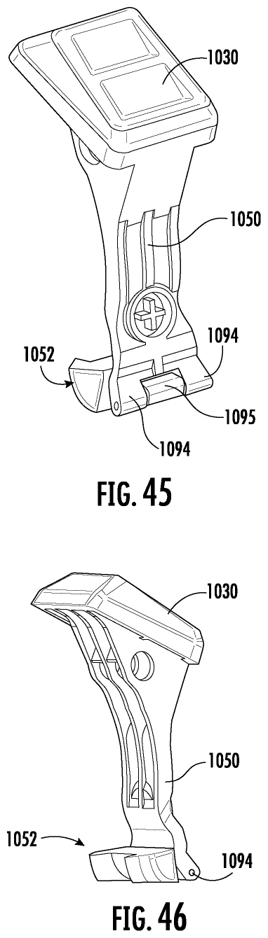

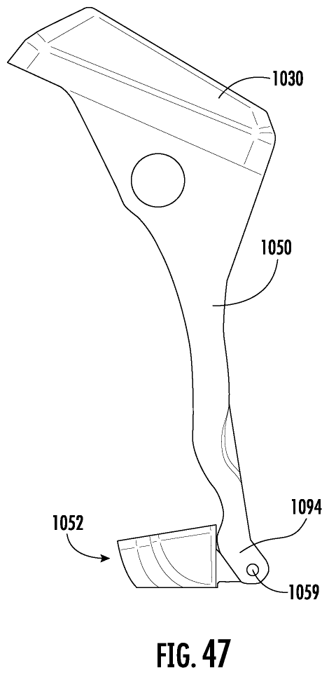

Referring to FIGS. 45-47, details of a brake arm 1050 and brake 1052 that can be utilized with brake mechanism 928 are shown according to an exemplary embodiment. Brake arm 1050 and brake 1052 are substantially the same as brake arm 950 and brake 952 except for the differences discussed herein. In specific embodiments, second end of brake 1052 includes a connector 1095 positioned between prongs 1094 extending from brake arm 1050. In various embodiments, prongs 1094 are coupled to connector 1095 of brake 1052 via a connector shown as pin 1059.

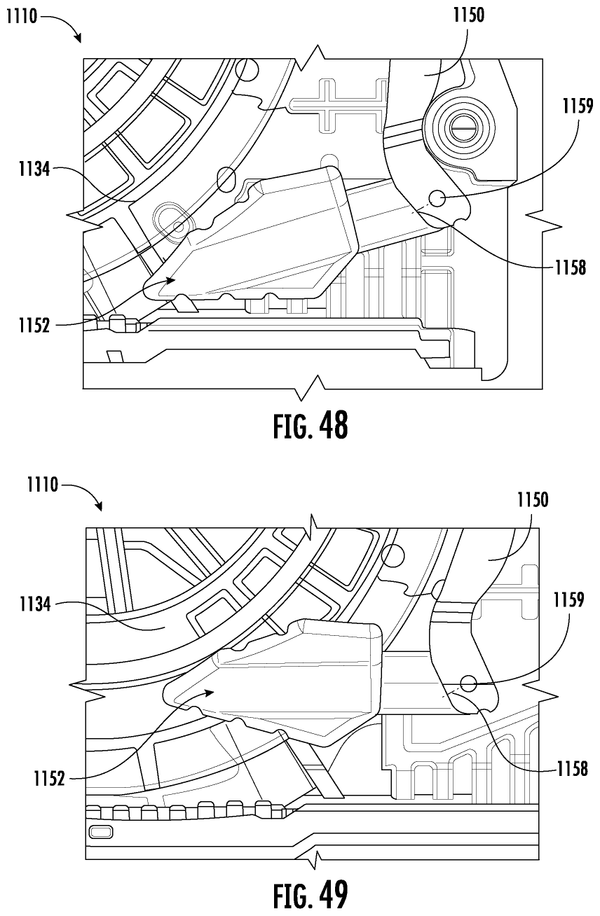

Referring to FIGS. 48-50, details of an assembly for a brake are shown according to another exemplary embodiment. Applicant believes the assembly discussed herein allows a brake to pivot throughout the life of the components. Brake 1152 can be utilized with brake mechanism 928 and/or tape measure 910.

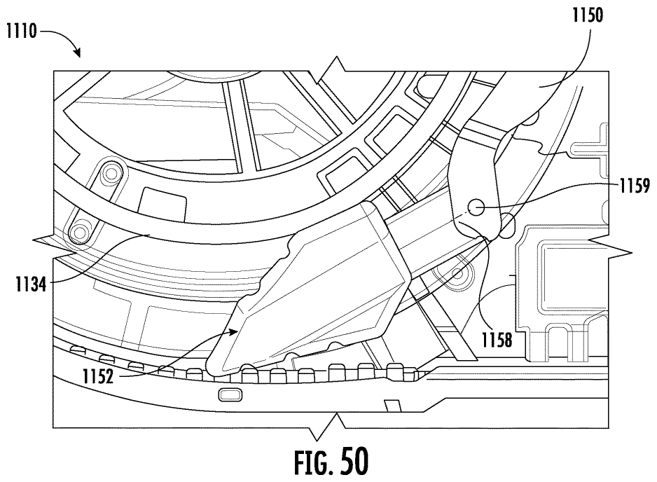

Referring to FIG. 48, brake 1152 is in a first position spaced from or disengaged from tape reel 1134. In specific embodiments, a pin 1159 couples brake 1152 to brake arm 1150 such that brake 1152 is pivotable about axis 1158. As shown in FIG. 49, when brake 1152 engages or interfaces against reel 1134, brake 1152 has pivoted about axis 1158 within the housing and relative to the reel 1134. As shown in FIG. 50, as brake 1152 and brake arm 1150 have pivoted into a different engagement position as a diameter of the tape blade is reduced. In this manner, the brake mechanism can continue to resist retraction of the tape blade even as the tape is unwound.

In various embodiments, the tape measures discussed herein have a tape blade length of about 16 ft, 25 ft, or 30 ft. In various embodiments, the tape measure is a digital tape measure.

It should be understood that the figures illustrate the exemplary embodiments in detail, and it should be understood that the present application is not limited to the details or methodology set forth in the description or illustrated in the figures. It should also be understood that the terminology is for the purpose of description only and should not be regarded as limiting.

Further modifications and alternative embodiments of various aspects of the disclosure will be apparent to those skilled in the art in view of this description. Accordingly, this description is to be construed as illustrative only. The construction and arrangements, shown in the various exemplary embodiments, are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present disclosure.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more component or element, and is not intended to be construed as meaning only one.

For purposes of this disclosure, the term “coupled” means the joining of two components directly or indirectly to one another. Such joining may be stationary in nature or movable in nature. Such joining may be achieved with the two members and any additional intermediate members being integrally formed as a single unitary body with one another or with the two members or the two members and any additional member being attached to one another. Such joining may be permanent in nature or alternatively may be removable or releasable in nature. As used herein, “rigidly coupled” refers to two components being coupled in a manner such that the components move together in a fixed positional relationship when acted upon by a force.

While the current application recites particular combinations of features in the claims appended hereto, various embodiments of the invention relate to any combination of any of the features described herein whether or not such combination is currently claimed, and any such combination of features may be claimed in this or future applications. Any of the features, elements, or components of any of the exemplary embodiments discussed above may be used alone or in combination with any of the features, elements, or components of any of the other embodiments discussed above.

In various exemplary embodiments, the relative dimensions, including angles, lengths and radii, as shown in the Figures are to scale. Actual measurements of the Figures will disclose relative dimensions, angles and proportions of the various exemplary embodiments. Various exemplary embodiments extend to various ranges around the absolute and relative dimensions, angles and proportions that may be determined from the Figures. Various exemplary embodiments include any combination of one or more relative dimensions or angles that may be determined from the Figures. Further, actual dimensions not expressly set out in this description can be determined by using the ratios of dimensions measured in the Figures in combination with the express dimensions set out in this description.

What is claimed is:

1. A tape measure comprising:
a housing;
an axle coupled to the housing;
a reel rotatably mounted within the housing around the axle;
an elongate blade wound around the reel;
an actuator at least partially positioned within the housing;
a brake arm positioned within the housing and extending from the actuator;
a brake pivotably coupled to the brake arm; and
a compression spring comprising a first end and a second end opposite the first end, wherein the first end interfaces against an interior surface of the housing and the second end engages the brake arm;
wherein the compression spring biases the brake into engagement with the elongate blade to resist retraction of the elongate blade.

2. The tape measure of claim 1, wherein the brake acts as a wedge between the elongate blade and the reel.

3. The tape measure of claim 1, wherein the housing further comprises a ramp rotatably mounting within the housing between the brake arm and the reel.

4. The tape measure of claim 3, wherein the ramp comprises an engagement surface that interfaces against an upper surface of the brake to resist movement of the brake toward the reel.

5. The tape measure of claim 1, wherein the first end of the compression spring has a first diameter and the second end of the compression spring has a second diameter.

6. The tape measure of claim 5, wherein the first diameter is the same as the second diameter.

7. The tape measure of claim 5, wherein the first diameter is different than the second diameter.

8. The tape measure of claim 1, wherein the compression spring is a cylindrical compression spring.

9. The tape measure of claim 1, wherein the brake arm is integrally formed with the actuator.

10. A tape measure comprising:
a housing;
an axle coupled to the housing;
a reel mounted within the housing and rotatable about the axle;
an elongate blade wound around the reel;
an actuator extending at least partially outside of the housing;
a brake arm positioned within the housing and extending from the actuator;
a housing protrusion positioned within the housing between the brake arm and the reel;
a brake pivotally coupled to the brake arm, wherein the brake comprises:
an upper surface configured to engage the housing protrusion; and
a lower surface opposing the upper surface and configured to engage the elongate blade to resist retraction of the elongate blade; and
a biasing component positioned between an interior surface of the housing and the brake arm, the biasing component biasing the brake toward engagement with the elongate blade.

11. The tape measure of claim 10, wherein the housing protrusion comprises a ramp with an angled engagement surface that faces the brake.

12. The tape measure of claim 11, wherein the ramp is rotatably coupled to the housing.

13. The tape measure of claim 10, wherein the housing protrusion is a cylindrical protrusion extending inward from an interior surface of the housing.

14. The tape measure of claim 13, wherein the cylindrical protrusion is fixedly coupled to the interior surface of the housing.

15. The tape measure of claim 10, wherein the brake arm is moveable between a first position in which brake is spaced from the housing protrusion and a second position in which the brake interfaces against the housing protrusion, and wherein an angular movement of the brake arm between the first position and the second position is less than 25 degrees.

16. A tape measure comprising:
a housing;
an axle coupled to the housing;
a reel rotatably mounted to the housing, the reel rotatable around the axle;
a tape blade wound around the reel;
an actuator extending at least partially outside of the housing;
a brake arm positioned within the housing and extending from the actuator, the brake arm comprising an engagement portion;
a housing protrusion positioned within the housing between the brake arm and the reel;
a brake coupled to the engagement portion of the brake arm, the brake comprising:
an upper surface; and
a lower surface opposing the upper surface and configured to engage the tape blade to resist retraction of the tape blade; and
a biasing component positioned between a surface of the housing and the brake arm, the biasing component biasing the brake toward engagement with the tape blade;
wherein, the housing protrusion interfaces against the upper surface of the brake to resist movement of the brake toward the reel.

17. The tape measure of claim 16, wherein the reel comprises a radially inward facing surface defining an interior reel cavity, and wherein a retraction mechanism is positioned within the interior reel cavity, the retraction mechanism configured to drive rewinding of the tape blade onto the reel.

18. The tape measure of claim 17, wherein the brake arm is moveable between a first position in which brake is spaced from the housing protrusion and a second position in which the brake interfaces against the housing protrusion.

19. The tape measure of claim 18, wherein an angular movement of the brake arm between the first position and the second position is less than 25 degrees.

20. The tape measure of claim 19, wherein the angular movement of the brake arm between the first position and the second position is less than 20 degrees.
